(19) United States
(12) Patent Application Publication
(10) Pub. No.: US 2024/0308480 A1
(43) Pub. Date: Sep. 19, 2024

(54) Device And Method for Preventing a Parked Vehicle from Rolling Away

(71) Applicant: Vitesco Technologies GmbH, Regensburg (DE)

(72) Inventor: Hong Zhang, Tegernheim (DE)

(73) Assignee: Vitesco Technologies GmbH, Regensburg (DE)

(21) Appl. No.: 18/614,787

(22) Filed: Mar. 25, 2024

Related U.S. Application Data
(63) Continuation of application No. PCT/EP2022/075051, filed on Sep. 9, 2022.

(30) Foreign Application Priority Data
Sep. 28, 2021 (DE) 10 2021 210 786.9

(51) Int. Cl. B60T 1/00; B60T 7/12; B60T 13/74

(52) U.S. Cl. CPC B60T 1/005; B60T 7/12; B60T 13/741

(57) ABSTRACT

A device for preventing a parked vehicle, such as an electric or hydraulic vehicle, from rolling away. The device includes a blocking device, which can be activated by electronic actuation, for immobilizing a movement of the vehicle. The device also includes a determination device configured to determine whether the vehicle is moving or not, and a control device configured to determine whether the blocking device has been activated or not. If the blocking device has been activated, the control device prompts the determination device to determine whether the vehicle is moving or not. If the determination device determines that the vehicle is moving, the control device actuates an electric motor of the vehicle for driving the vehicle to stop the movement of the vehicle and maintain the stopped state of the vehicle.

### CROSS-REFERENCE TO RELATED APPLICATIONS

This application claims the benefit of PCT Application PCT/EP2022/075051, filed Sep. 9, 2022, which claims priority to German Application 10 2021 210 786.9, filed Sep. 28, 2021. The disclosures of the above applications are incorporated herein by reference.

### TECHNICAL FIELD

The disclosure relates to a device and to a method for preventing a parked vehicle, such as an electric or hybrid vehicle, from rolling away, as well as to a vehicle which has the device.

### BACKGROUND

The blocking device customarily used in vehicles, which takes the form of a mechanical parking brake or hand brake, and is provided for the long-term blocking of one or more wheels of the vehicle in a parked state of the vehicle in order to prevent the parked vehicle from rolling away is often replaced, for example, in electric and hybrid vehicles, by a parking brake which can be activated by electronic actuation.

To prevent the vehicle from rolling away in the case of a malfunction of the parking brake which can be activated by electronic actuation, two blocking devices which take the form of parking brakes which can be activated by electronic actuation are often installed in a vehicle. One of these parking brakes serves as a redundant parking brake. Here, for example in vehicles which have an automatic transmission, one of the two parking brakes which can be activated by electronic actuation is replaced by a parking lock which can be activated by electronic actuation.

### SUMMARY

The disclosure provides an improved device and method for preventing a parked vehicle from rolling away.

One aspect of the disclosure provides a device for preventing a parked vehicle, such as an electric or hydraulic vehicle, from rolling away. The device includes a blocking device, which can be activated by electronic actuation, for immobilizing a movement of the vehicle. The device also includes a determination device configured to determine whether the vehicle is moving or not, and a control device configured to determine whether the blocking device has been activated or not. If the blocking device has been activated, the control device prompts the determination device to determine whether the vehicle is moving or not, and, if the determination device determines that the vehicle is moving, the control device actuates an electric motor of the vehicle for driving the vehicle to stop the movement of the vehicle and maintain the stopped state of the vehicle.

As a result, in some examples, just one blocking device for immobilizing the movement of the vehicle, for example a parking brake which can be activated by electronic actuation or a parking lock which can be activated by electronic actuation, can be installed in a vehicle because, in the case of a malfunction of the one blocking device, which can be identified on the basis of a movement of the vehicle, when the blocking device is activated, it is ensured, by way of the actuation of the electric motor for driving the vehicle in order to stop a movement of the vehicle and maintain the stopped state of the vehicle, that the vehicle does not roll away in spite of the malfunction of the blocking device. In this way, the cost of a second redundant blocking device can be saved and the effort to integrate a device for preventing a parked vehicle from rolling away can be reduced.

Implementations of the disclosure may include one or more of the following optional features. In some implementations, the device also includes a memory device and an output device. The control device is configured to save, in the memory device, information that the blocking device has a fault and to output it by way of the output device when the blocking device has been activated and the determination device determines that the vehicle is moving.

The output device may be designed, for example, as a display device on which the information that the blocking device has a fault and possibly a notification for the user that the blocking device needs to be repaired is outputted.

As a result, in some examples, it can be ensured that the user is informed about a malfunction of the blocking device and can take appropriate measures to repair the blocking device.

In some implementations, the control device has an electric motor control device and is configured to activate the electric motor control device when the blocking device has been activated. The electric motor control device is configured to actuate the electric motor to stop the movement of the vehicle and maintain the stopped state of the vehicle if the determination device determines that the vehicle is moving.

As a result, in some examples, it can be ensured that the electric motor control device is activated to possibly stop the movement of the vehicle and maintain the stopped state of the vehicle when the vehicle is parked, as a result of which the parked vehicle can be reliably prevented from rolling away.

In some implementations, the control device is configured to deactivate the electric motor control device if the determination device determines that the vehicle is not moving.

As a result, in some examples, energy can be saved which would be necessary to operate the electric motor control device if the determination device determines that the vehicle is not moving.

In some implementations, the control device is configured to prompt the determination device, after the deactivation of the electric motor, to continuously determine whether the vehicle is moving or not and, if the determination device determines that the vehicle is moving, to activate the electric motor control device in order to actuate the electric motor in order to stop the movement of the vehicle and maintain the stopped state of the vehicle.

As a result, in some examples, the parked vehicle can be prevented from rolling away as a result of a malfunction of the blocking device which occurs only after the deactivation of the electric motor control device.

In some implementations, the determination device is configured to detect a rotated position of a rotor of the electric motor and/or to detect a speed of rotation of a wheel of the vehicle and to determine that the vehicle is moving if the rotated position of the rotor of the electric motor changes or the speed of rotation of the wheel does not equal zero.

As a result, in some examples, it can be safely determined whether the vehicle is moving or not.

In some implementations, the blocking device is a parking lock which can be activated by electronic actuation to immobilize an output shaft of the electric motor or a parking lock which can be activated by electronic actuation to immobilize a transmission of the vehicle or a parking brake which can be activated by electronic actuation to immobilize at least one wheel of the vehicle.

The respective blocking device can here be activated automatically, for example when the gear selector of an automatic transmission is put into the park position, and/or manually by the user by way of a corresponding triggering device.

As a result, in some examples, it can be ensured in the case of a functional blocking device that the parked vehicle is prevented by the blocking device from rolling away.

In some implementations, the control device is configured to determine, based on a position of an actuator of the blocking device, whether the blocking device has been activated or not.

In some implementations, the control device is configured to regulate torque of the electric motor to stop the movement of the vehicle and maintain the stopped state of the vehicle.

The torque of the electric motor may be regulated to a value at which the (rotated) position or the angle of rotation of the rotor does not change or remains constant.

As a result, in some examples, setting an appropriate torque of the electric motor can prevent the parked vehicle from rolling away.

In some implementations, a vehicle, such as an electric or hybrid vehicle, has an abovedescribed device for preventing a parked vehicle, for example an electric or hybrid vehicle, from rolling away.

Another aspect of the disclosure provides a method for preventing a parked vehicle, such as an electric or hybrid vehicle, from rolling away. The method includes determining, by way of a control device, whether a blocking device for immobilizing a movement of the vehicle which can be activated by electronic actuation has been activated or not, prompting, by way of the control device, a determination device to determine whether the vehicle is moving or not if it has been determined by way of the control device that the blocking device has been activated, and actuating, by way of the control device, an electric motor of the vehicle for driving the vehicle in order to stop the vehicle and maintain the stopped state of the vehicle if the determination device determines that the vehicle is moving.

As a result, in some examples, just one blocking device for immobilizing the movement of the vehicle, for example a parking brake which can be activated by electronic actuation or a parking lock which can be activated by electronic actuation, can be installed in a vehicle because, in the case of a malfunction of the one blocking device, which can be identified based on a movement of the vehicle, when the blocking device is activated, it is ensured, by way of the actuation of the electric motor for driving the vehicle in order to stop a movement of the vehicle and maintain the stopped state of the vehicle, that the vehicle does not roll away in spite of the malfunction of the blocking device. In this way, the cost of a second redundant blocking device can be saved and the effort to integrate a device for preventing a parked vehicle from rolling away can be reduced.

In some implementations, the method moreover includes saving in a memory device, by way of the control device, information that the blocking device has a fault, and prompting, by way of the control device, an output device to output the information that the blocking device has a fault when the blocking device has been activated and it has been determined by way of the determination device that the vehicle is moving.

The output device can here be designed, for example, as a display device on which is output the information that the blocking device has a fault and possibly a notification for the user that the blocking device needs to be repaired.

As a result, in some examples, it can be ensured that the user is informed about a malfunction of the blocking device and can take appropriate measures to repair the blocking device.

In some implementations, the control device has an electric motor control device. The electric motor control device is activated by way of the control device when the blocking device has been activated. Additionally, the method also includes actuating, by way of the electric motor control device, the electric motor to stop the movement of the vehicle and maintain the stopped state of the vehicle if it is determined by way of the determination device that the vehicle is moving.

As a result, in some examples, it can be ensured that the electric motor control device is activated to possibly stop the movement of the vehicle and maintain the stopped state of the vehicle when the vehicle is parked, as a result of which the parked vehicle can be reliably prevented from rolling away.

In some implementations, the method also includes deactivating, by way of the control device, the electric motor control device if it is determined by the determination device that the vehicle is not moving.

As a result, in some examples, energy can be saved which would be necessary to operate the electric motor control device if the determination device determines that the vehicle is not moving.

In some implementations, the method moreover includes prompting, by way of the control device, the determination device, after the deactivation of the electric motor control device, to continuously determine whether the vehicle is moving or not. If it is determined by way of the determination device that the vehicle is moving, the method includes activating the electric motor control device, by the control device, to actuate the electric motor to stop the movement of the vehicle and maintain the stopped state of the vehicle.

As a result, in some examples, the parked vehicle can be prevented from rolling away as a result of a malfunction of the blocking device which occurs only after the deactivation of the electric motor control device.

In some implementation, the determining by way of the determination device whether the vehicle is moving or not includes detecting a rotated position of a rotor of the electric motor and/or detecting a speed of rotation of a wheel of the vehicle. The determination device determines that the vehicle is moving if the rotated position of the rotor of the electric motor changes or the speed of rotation of the wheel does not equal zero.

As a result, in some examples, it can be safely determined whether the vehicle is moving or not.

In some implementations, the blocking device is a parking lock which can be activated by electronic actuation to immobilize an output shaft of the electric motor or a parking lock which can be activated by electronic actuation to immobilize a transmission of the vehicle or a parking brake which can be activated by electronic actuation to immobilize at least one wheel of the vehicle.

The respective blocking device can here be activated automatically, for example when the gear selector of an automatic transmission is put into the park position, and/or manually by the user by way of a corresponding triggering device.

As a result, in some examples, it can be ensured in the case of a functional blocking device that the parked vehicle is prevented by the blocking device from rolling away.

In some implementations, the control device determines based on a position of an actuator of the blocking device whether the blocking device has been activated or not.

In some examples, torque of the electric motor is regulated by way of the control device to stop the movement of the vehicle and maintain the stopped state of the vehicle.

The torque of the electric motor is regulated to a value at which the (rotated) position or the angle of rotation of the rotor does not change or remains constant.

As a result, in some examples, setting an appropriate torque of the electric motor can prevent the parked vehicle from rolling away.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a vehicle with a device for preventing a parked vehicle from rolling away.

FIG. 2 shows a flow diagram for illustrating a method for preventing a parked vehicle from rolling away.

Like reference symbols in the various drawings indicate like elements.

### DETAILED DESCRIPTION

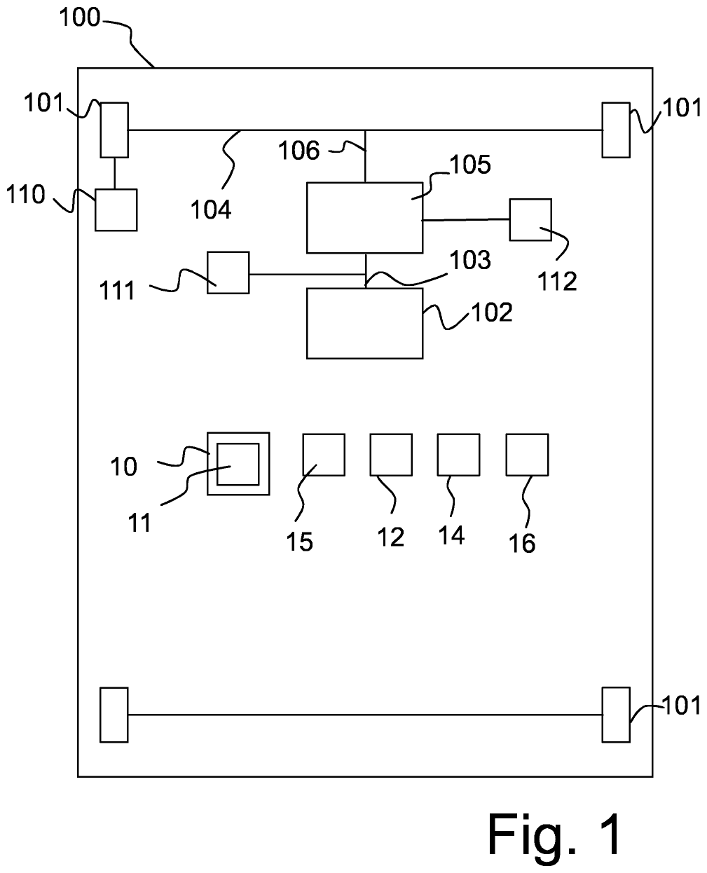

FIG. 1 shows a vehicle 100 with an exemplary device for preventing a parked vehicle 100 from rolling away.

The vehicle 100, which takes the form of an electric or hybrid vehicle, has an electric motor 102 for driving the vehicle 100. An output shaft 103 of the electric motor 102, which is connected non-rotatably to a rotor of the electric motor 102, serves as an input shaft of a transmission 105, such as an automatic transmission, of the vehicle 100 or is connected to an input shaft of the transmission 105. A transmission ratio, i.e., a ratio between a speed of rotation of the output shaft 103 of the electric motor 102 and a speed of rotation of an output shaft 106 of the transmission 105 can be set, such as be set steplessly, by way of the transmission 105. The output shaft 106 of the transmission 105 is connected via an axle 104 to wheels 101 of the vehicle 100, which are assembled thereon, to drive the wheels by way of the electric motor 102.

In some examples, the output shaft 103 of the electric motor 102 can also be connected to the wheels 101 to drive them, without the interposition of a transmission.

To prevent the vehicle 100 from rolling away in a parked state of the vehicle 100, the device for preventing a parked vehicle 100 from rolling away may include a single blocking device 110, 111, 112. The blocking device 110, 111, 112 can be designed, for example, as a parking lock 111, which can be activated by electronic actuation, for immobilizing the output shaft 103 of the electric motor 102 or as a parking lock 112, which can be activated by electronic actuation, for immobilizing the transmission 105, for example a differential transmission, of the vehicle 100 or as a parking brake 110, which can be activated by electronic actuation, for immobilizing at least one wheel 101 of the vehicle 100.

To activate the respective blocking device 110, 111, 112, a triggering device 16, designed for example as a switch, can be provided which is electrically connected to an actuator of the corresponding blocking device 110, 111, 112. When the triggering device 16 is triggered by a user, an electric signal is sent from it to the blocking device 110, 111, 112 or the actuator to activate the blocking device 110, 111, 112. Additionally or alternatively, the respective blocking device 110, 111, 112 can also be activated automatically, for example when the gear selector of a transmission 105 in the form of an automatic transmission is put in the park position, in a manner controlled by a control device 10.

The device for preventing a parked vehicle 100 from rolling away moreover has a determination device 15 which is configured to determine whether the vehicle 100 is moving or not. The determination device 15 can here be configured, for example, to detect a rotated position of a rotor of the electric motor 102 and/or to detect a speed of rotation of a wheel 101 of the vehicle 100 and to determine that the vehicle 100 is moving if the rotated position of the rotor of the electric motor 102 changes or the speed of rotation of the wheel 101 does not equal zero.

The control device 10 is moreover configured to determine whether the blocking device 110, 111, 112 has been activated or not. For this purpose, the control device 10 can be configured, for example, to determine, based on a position (triggered position or non-triggered position) of the actuator of the blocking device 110, 111, 112 whether the blocking device 110, 111, 112 has been activated or not.

The control device 10 is configured to prompt the determination device 15 to determine whether the vehicle 100 is moving or not when the control device 10 has previously determined that the blocking device 110, 111, 112 has been activated.

If the determination device 15 determines that the vehicle 100 is moving, the control device 10 is configured to actuate the electric motor 102 of the vehicle 100 for driving the vehicle 100 to stop the movement of the vehicle 100 and maintain the stopped state of the vehicle 100. For this purpose, the control device 10 is configured to regulate torque of the electric motor 102 to stop the movement of the vehicle 100 and maintain the stopped state of the vehicle 100. The torque of the electric motor 102 is here regulated to a value at which the (rotated) position or the angle of rotation of the rotor does not change or remains constant.

The device for preventing a parked vehicle 100 from rolling away moreover has a memory device 12 and an output device 14. The control device 10 is configured to save in the memory device 12 information that the blocking device 110, 111, 112 has a fault and to output it by way of the output device 14 if the blocking device 110, 111, 112 has been activated and the determination device 15 determines that the vehicle 100 is moving. The output device 14 can here be designed, for example, as a display device on which is output the information that the blocking device 110, 111, 112 has a fault and possibly a notification for the user that the blocking device 110, 111, 112 needs to be repaired.

In some examples, the control device 10 has an electric motor control device 11 and is configured to activate the electric motor control device 11 if the blocking device 110, 111, 112 has been activated. In this case, the electric motor control device 11 is configured to actuate the electric motor 102, specifically to regulate the torque of the electric motor 102 to stop the movement of the vehicle 100 and maintain the stopped state of the vehicle 100 if the determination device 15 determines that the vehicle 100 is moving. The control device 10 is furthermore configured to deactivate the electric motor control device 11 if the determination device 15 determines that the vehicle 100 is not moving, and to prompt the determination device 15, after the deactivation of the electric motor control device 11, to continuously determine whether the vehicle 100 is moving or not and, if the determination device 15 determines that the vehicle 100 is moving, to activate the electric motor control device 11 in order to actuate the electric motor 102 in order to stop the movement of the vehicle 100 and maintain the stopped state of the vehicle 100.

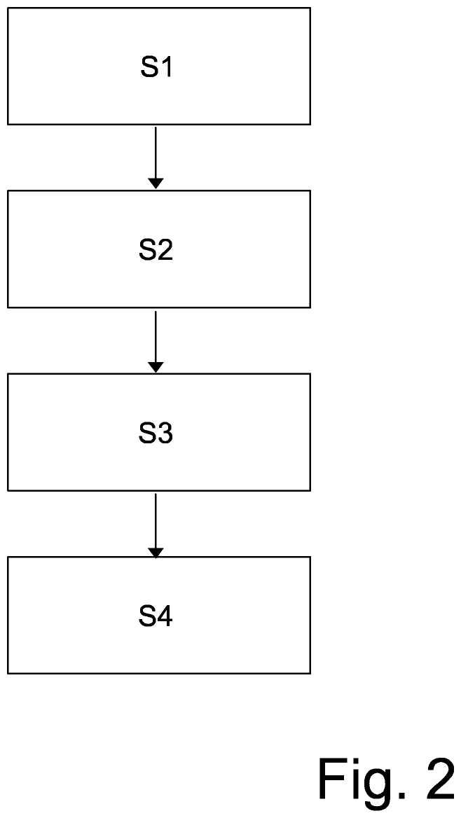

FIG. 2 shows a flow diagram for illustrating an exemplary method for preventing a parked vehicle from rolling away.

In step S1, it is determined by way of the control device 10 whether a blocking device 110, 111, 112 for immobilizing a movement of the vehicle 100, which can be activated by electronic actuation, has been activated or not. The blocking device 110, 111, 112 can here be the parking lock 111, which can be activated by electronic actuation, for immobilizing the output shaft 103 of the electric motor 102, or the parking lock 112, which can be activated by electronic actuation, for immobilizing the transmission 105 of the vehicle 100, or the parking brake 110, which can be activated by electronic actuation, for immobilizing at least one wheel 101 of the vehicle 100. The control device 10 can here moreover determine, based on a position of an actuator of the blocking device 110, 111, 112, whether the blocking device 110, 111, 112 has been activated or not.

In step S2, a determination device 15 is prompted by way of the control device 10 to determine whether the vehicle 100 is moving or not when it has been determined by way of the control device 10 that the blocking device 110, 111, 112 has been activated. The determining by way of the determination device 15 whether the vehicle 100 is moving or not can here include detecting a rotated position of a rotor of the electric motor 102 and/or detecting a speed of rotation of a wheel 101 of the vehicle 100, where it is determined by way of the determination device 15 that the vehicle 100 is moving if the rotated position of the rotor of the electric motor 102 changes or the speed of rotation of the wheel 101 does not equal zero.

In step S3, the electric motor 102 of the vehicle 100 for driving the vehicle 100 is actuated by way of the control device 10 to stop the movement of the vehicle 100 and maintain the stopped state of the vehicle 100 if the determination device 15 determines that the vehicle 100 is moving. Torque of the electric motor 102 can here be regulated by way of the control device 10 to stop the movement of the vehicle 100 and maintain the stopped state of the vehicle 100.

In an optional step S4, information that the blocking device 110, 111, 112 has a fault is saved in a memory device 12 by way of the control device 10, and an output device 14, for example in the form of a display device, is prompted by way of the control device 10 to output the information that the blocking device 110, 111, 112 has a fault if the blocking device 110, 111, 112 has been activated and it has been determined by way of the determination device 15 that the vehicle 100 is moving.

In some implementations, the control device 10 has an electric motor control device 11 which, in step S2, is activated by way of the control device 10 if the blocking device 110, 111, 112 has been activated. In this case, in step S3, the electric motor 102 is actuated by way of the electric motor control device 11 to stop the movement of the vehicle 100 and maintain the stopped state of the vehicle 100 if it is determined by way of the determination device 15 that the vehicle 100 is moving. Deactivation, by way of the control device 10, of the electric motor control device 11 here moreover takes place if it is determined by the determination device 15 that the vehicle 100 is not moving. After the deactivation of the electric motor control device 11, the determination device 15 is then prompted, by way of the control device 10, to continuously determine whether the vehicle 100 is moving or not, and, if it is determined by way of the determination device 15 that the vehicle 100 is moving, the electric motor control device 11 is activated by the control device 10 in order to actuate the electric motor 102 in order to stop the movement of the vehicle 100 and maintain the stopped state of the vehicle 100.

A number of implementations have been described. Nevertheless, it will be understood that various modifications may be made without departing from the spirit and scope of the disclosure. Accordingly, other implementations are within the scope of the following claims.

What is claimed is:

1. A device for preventing a parked vehicle from rolling away, the device comprising:
a blocking device activated by electronic actuation for immobilizing a movement of the vehicle;
a determination device configured to determine whether the vehicle is moving or not; and
a control device configured to determine whether the blocking device has been activated or not and, if the blocking device has been activated, the control device prompts the determination device to determine whether the vehicle is moving or not, and, if the determination device determines that the vehicle is moving, the control device actuates an electric motor of the vehicle for driving the vehicle in order to stop the movement of the vehicle and maintain a stopped state of the vehicle.

2. The device of claim 1, wherein the vehicle is an electric vehicle or a hybrid vehicle.

3. The device of claim 1, further comprising a memory device and an output device, wherein the control device is configured to save in the memory device information that the blocking device has a fault and to output it, by the output device, when the blocking device has been activated and the determination device determines that the vehicle is moving.

4. The device of claim 1, wherein the control device has an electric motor control device and is configured to activate the electric motor control device when the blocking device has been activated, and the electric motor control device is configured to actuate the electric motor in order to stop the movement of the vehicle and maintain the stopped state of the vehicle if the determination device determines that the vehicle is moving.

5. The device of claim 4, wherein the control device is configured to deactivate the electric motor control device if the determination device determines that the vehicle is not moving.

6. The device of claim 5, wherein the control device is configured to prompt the determination device, after the deactivation of the electric motor control device, to continuously determine whether the vehicle is moving or not and, if the determination device determines that the vehicle is moving, to activate the electric motor control device in order to actuate the electric motor in order to stop the movement of the vehicle and maintain the stopped state of the vehicle.

7. The device of claim 1, wherein the determination device is configured to detect a rotated position of a rotor of the electric motor and/or to detect a speed of rotation of a wheel of the vehicle and to determine that the vehicle is moving if the rotated position of the rotor of the electric motor changes or the speed of rotation of the wheel does not equal zero.

8. The device of claim 1, wherein the blocking device is a parking lock, which can be activated by electronic actuation, for immobilizing an output shaft of the electric motor, or a parking lock, which can be activated by electronic actuation, for immobilizing a transmission of the vehicle, or a parking brake, which can be activated by electronic actuation, for immobilizing at least one wheel of the vehicle.

9. The device of claim 1, wherein the control device is configured to determine, based on a position of an actuator of the blocking device, whether the blocking device has been activated or not.

10. The device of claim 1, wherein the control device is configured to regulate torque of the electric motor to stop the movement of the vehicle and maintain the stopped state of the vehicle.

11. A vehicle having a device as claimed in claim 1.

12. A method for preventing a parked vehicle from rolling away, the method comprising:
determining, at a control device, whether a blocking device for immobilizing a movement of the vehicle has been activated or not, the blocking device can be activated by electronic actuation;
prompting, by the control device, a determination device to determine whether the vehicle is moving or not when it has been determined by the control device that the blocking device has been activated; and
actuating, by the control device, an electric motor of the vehicle for driving the vehicle to stop the movement of the vehicle and maintain a stopped state of the vehicle if the determination device determines that the vehicle is moving.

13. The method of claim 12, further comprising:
saving, in a memory device by the control device, information that the blocking device has a fault; and
prompting, by the control device, an output device to output the information that the blocking device has a fault when the blocking device has been activated and the determination device has determined that the vehicle is moving.

14. The method of claim 12,
wherein the control device has an electric motor control device activated, by the control device, when the blocking device has been activated, and
wherein the method further comprises actuating, by the electric motor control device, the electric motor to stop the movement of the vehicle and maintain the stopped state of the vehicle if the determination device determines that the vehicle is moving.

15. The method of claim 14, further comprising deactivation, by the control device, of the electric motor control device if the determination device determines that the vehicle is not moving.

16. The method of claim 15, further comprising:
prompting, by the control device, the determination device, after the deactivation of the electric motor control device, to continuously determine whether the vehicle is moving or not; and
if the determination device determines that the vehicle is moving, activating the electric motor control device, by the control device, to actuate the electric motor to stop the movement of the vehicle and maintain the stopped state of the vehicle.

17. The method of claim 12, wherein determining by the determination device whether the vehicle is moving or not includes:
detecting a rotated position of a rotor of the electric motor and/or detecting a speed of rotation of a wheel of the vehicle, and
if the rotated position of the rotor of the electric motor changes or the speed of rotation of the wheel does not equal zero, then a determination that the vehicle is moving is made.

18. The method of claim 12, wherein the blocking device is a parking lock, which can be activated by electronic actuation, for immobilizing an output shaft of the electric motor, or a parking lock, which can be activated by electronic actuation, for immobilizing a transmission of the vehicle, or a parking brake, which can be activated by electronic actuation, for immobilizing at least one wheel of the vehicle.

19. The method of claim 12, wherein the control device determines, based on a position of an actuator of the blocking device, whether the blocking device has been activated or not.

20. The method of claim 12, wherein torque of the electric motor is regulated by the control device to stop the movement of the vehicle and maintain the stopped state of the vehicle.
